(19) United States
(12) Patent Application Publication
(10) Pub. No.: US 2018/0056585 A1
(43) Pub. Date: Mar. 1, 2018

(54) IMPROVEMENTS IN 3D PRINTING

(71) Applicant: GIZMO 3D PRINTERS, Bracken Ridge (AU)

(72) Inventor: Kobus Du Toit, Bracken Ridge (AU)

(21) Appl. No.: 15/528,004

(22) PCT Filed: May 12, 2016
(86) PCT No.: PCT/AU2016/050359

§ 371 Date: May 18, 2017

(30) Foreign Application Priority Data
May 12, 2015 (AU) 2015901721
Jun. 10, 2015 (AI) 2015902170

(51) Int. Cl. B29C 64/129; B29C 35/08; B29C 64/236

(52) U.S. Cl. CPC B29C 64/129; B29C 35/0805; B33Y 10/00; B29C 2035/0827; B29C 64/236

(57) ABSTRACT

A method of 3D printing an article is described, the method comprising the steps of projecting images onto a liquid resin from a plurality of cooperating image sources; aligning the images from the first and second sources at least in a single 2D plane in the liquid resin; moving a plate relative to the 2D plane, wherein the moving is substantially continuous; and allowing the liquid resin to cure upon expose to the image in the 2D plane, thereby forming the printed article. The curing of the resin under the influence of the light emitted from the plurality of image sources can allow for a fast printing process.

### TECHNICAL FIELD

The present invention relates to 3D printing.

### BACKGROUND

3D printing is an additive manufacturing method that can be used to create a wide variety of objects. In some instances, 3D printing can produce objects that cannot otherwise be created using traditional manufacturing processes. To create an object using a 3D printer, a layer of material is deposited across a 2D plane, and then another layer of material is deposited on top of the previous layer. This process is repeated multiple times until the final object is obtained. This type of manufacture can also be known as layer-by-layer manufacture, bottom-up-manufacture, or additive manufacture.

Because 3D printers use a layer-by-layer approach to create an object, the time required to create the object is primarily determined by the time taken to deposit each layer. The time increases significantly as the size of the object increases. Therefore, the speed of creating objects still remains an issue in using 3D printing for widespread manufacturing processes.

Plastics are often used to form objects created by 3D printing. To date, many consumer and prototyping 3D printers rely on extruding a molten plastic through a needle at the point of deposition. 3D printers that extrude molten plastic are cheap and simple to operate. However, the time required to melt, deposit and then allow the molten plastic to solidify is often the rate limiting step in the time required to deposit each layer. Further, inadequate deposition can lead to structural flaws in the object that can affect its mechanical properties. The resolution of 3D printed objects using extruded plastics is approximately 100 μm. This can be improved, but it is often at a sacrifice for the time required to deposit each layer.

3D printers that use methods to polymerise resins often have better resolution than their extruded plastic counterparts, but they are more expensive. The operation processes involved in creating an object using resins is also more complex due to the use of specialty lights, lasers or tracking systems.

There is a need for a 3D printing process that is relatively faster than the printing processes known in the art. It is to be understood that, if any prior art publication is referred to herein, such reference does not constitute an admission that the publication forms a part of the common general knowledge in the art, in Australia or any other country.

### SUMMARY OF INVENTION

According to a first aspect of the invention there is provided a method of 3D printing an article comprising the steps of
projecting an image onto a liquid resin from a first image source;
projecting an image onto the liquid resin from a second image source;
aligning the images from the first and second sources at least in a single 2D plane in the liquid resin; and
allowing the liquid resin to cure in the single 2D plane upon exposure to the projected images.

There can be any number of image sources arranged so as to project an image onto the liquid resin. Each image source can project the same image onto the liquid resin. The image sources can be aligned so that the projected images substantially overlap. The overlapped images can form the complete image that is printed. The combined images can have a greater brightness than any single image generated by a single image source. Each image source can project a part of an image (sub-image) onto the liquid resin. The image sources can be aligned so that adjacent edges of each sub-image abut one another. The abutted images can form the complete image that is printed. The liquid resin is cured upon exposure to the light from one or more image sources. The curing of the resin under the influence of the light emitted from the plurality of image sources can allow for a fast printing process.

According to another aspect of the invention there is provided a method of 3D printing an article comprising the steps of
projecting images onto a liquid resin from a plurality of cooperating image sources;
aligning the images from the first and second sources at least in a single 2D plane in the liquid resin; and
moving a plate located substantially in the liquid resin, and the 2D plane, relative to one another;
allowing the liquid resin to cure upon expose to the image from the image sources, thereby forming the printed article.

The curing of the resin under the influence of the light emitted from the plurality of image sources can allow for a continuous printing process that can be much faster than known 3D printing processes.

The description in relation to the first aspect applies to the other aspects of the invention. The description that follows applies to all aspects of the invention disclosed herein, unless the context makes clear otherwise.

In an embodiment, the images from the first and second sources are substantially the same. In an embodiment, the images from the first and second sources are at least partially the same. In an embodiment, the first and second images substantially overlap at least in a single 2D plane in the liquid resin. In an embodiment, the images from the first and second sources are different. When the images are different, it is because they are intended to be aligned at their edges so as to be joined to form the complete image.

Each image source can be a projector. The projector can be one that uses a digital micromirror device such as a Digital Light Projector (DLP). The image source may also comprise screens made from liquid crystal displays (LCD) and/or light emitting diodes (LED), or any other source that can project an image onto the resin. The source could also include for example a laser source. Although a laser per se does not project an image, it can be used to generate the individual pixels one at a time to create an image. Use of a laser would typically require a tracking system. The source can have any definition. For example, the image source can project a low resolution, High Definition (HD), Ultra HD and Ultra Ultra HD image. Higher definition sources may also be used. The first and second image sources can be the same. In one embodiment, the first and second image sources are each DLP. The first and the second image sources can be different. For example, a DLP can be used as the first image source and a laser can be used as the second image source. In such circumstances, the DLP may project the majority of the pixels that make up the image and the laser may provide specific pixels around the periphery of the image to improve resolution. There can be more than two image sources. The more than two image sources can be the same or they can be different. There can be any number of image sources oriented so as to each project an image onto (and into) the liquid resin. Where there are more than two image sources, each additional image source can project an image onto the liquid resin that is the same as the image from the other image sources. Regardless of the number of image sources used, the images are preferably substantially overlapped.

Multiple sub-images can be projected onto the liquid resin from the same image source. Each sub-image can form a part of a complete image. For example, five rings may be projected onto the liquid resin by each of two image sources, where the two image sources project a total of 10 rings. In one form, part of the image from one image source and a part of the image from another image source can be delivered in sub images, e.g. as stripes where some stripes are from one image source and some stripes from another image source and some of the sub-images are aligned to overlap to form the complete image. This may help to reduce hotspots to prevent unnecessary polymerisation of the liquid resin.

Also described herein is that a complete image may be projected from a plurality of image sources. For example, one half of an image may be projected using one source, and the other half of the image may be projected using a second source, where each half is aligned with one another to produce one complete image. In this type of arrangement, the number of sub-images of a projected complete image can be proportional to the number of image sources. For example, 16 image sources can project 16 segments that are substantially aligned to produce one complete image. This arrangement may allow large objects to be printed with high resolution. The number of image sources needed may be determined by the size and/or area of the printed object. For example, 20 images may be projected from rows of projectors. There can be any number of rows for example, 2 to 10 rows. There can be projectors provided in addition to the rows. In one embodiment 20 images are provided by e.g.:2 rows of 10 projectors, 4 row of 5 projectors, 3 rows by 6 projectors with 2 addition projectors, 8 rows by 2 projectors with 4 additional projectors, or 9 rows by 2 projectors with 2 additional projectors. In such cases, the edges of each projected image may abut one another to form the complete image or may be partially overlapped. The terms complete image and image will be used interchangeably throughout this disclosure.

Also described herein is that an image may be spread across a plurality of image source units, where each image source unit has two or more image sources. For example, there may be two, three, four, five image source units (each unit having at least a first image source and a second image source) that each project one part such as one half of a final image i.e. two sub-images. Each image source unit may comprise more than one projector. In an embodiment, there may be two (or more) DLP in each image source unit. In this example, each image projected by e.g. two image sources in each image source unit are substantially similar and substantially overlapped. Regardless of the number of image sources in the image source units, there can be any number of image source units to construct a final image. In addition, regardless of the number of image source units used and how they are arranged, there may be any number of computers and/or programs used to construct the complete image from the number of sub-images projected from the number of image source units.

The image sources can be disposed above the resin bath with the lamps oriented towards the resin bath. The image sources can be disposed below the resin bath. Optionally, the at least one image source can be disposed on the side of the resin bath. The lamp in at least one of the image sources can be an ultraviolet (UV) lamp, a broad spectrum lamp, and/or a LED lamp. The intensity of the lamp in the image source can determine the rate of curing of the liquid resin. For example, a lamp with a low intensity would typically take longer to cure the resin when compared to a lamp with a higher intensity. In an embodiment, a 180 Watt lamp will cure a layer of resin of 0.05 mm in approximately 1 or 2 seconds. In another embodiment, a 240 Watt lamp will cure a layer of resin of 0.05 mm in approximately 0.5 or 1 second. The combined intensity of the lamps from multiple image sources increases the amount of light energy delivered to the liquid resin. Using two or more image sources means that each source may not need to be operated at full power, and that a lower power setting, for example, using at most about 30, 40, 50, 60 or 75%, of the full possible intensity may be sufficient to polymerise the resin. Using lower output settings may help to increase the life of the image source. In some embodiments, higher intensity light may be a disadvantage as it may prematurely polymerise the liquid resin. The wavelength of the light emitted from the image source may also determine the time taken to cure the resin. For example, higher energy wavelengths, such as those commonly found in a UV light source, typically cure resin faster than lower energy wavelengths.

In an embodiment, the intensity of the light being projected into the resin is at least about 500, 1000, 2000, 2500, 3000 or 3500 lumens. The intensity of the light may be lower than 500 lumens for highly active resin.

The image sources can each project an image onto a top surface of the liquid resin. The top surface of the liquid resin can be self-levelling under forces of gravity in the resin bath. The top surface of the liquid resin can be exposed to the ambient atmosphere. The surface of the liquid resin can be exposed to a vacuum. The liquid resin can be exposed to gases other than those present in an ambient atmosphere, for example insert gases such as nitrogen and/or argon. The surface of the liquid resin may also be exposed to both a vacuum and inert gases. The resin bath can comprise a movable plate disposed within it. The plate can be moved manually or mechanically. Preferably, the plate is moved mechanically under instruction from an external computer. However, an internal computer may be used in place of or in addition to the external computer to move the plate. Prior to printing, the plate in the resin bath can be at (or just below) the top surface of the liquid resin. This means that the first layers of cured resin can form on the plate. The plate therefore can act as a support for the printed article as it forms. As the resin cures in each 2D plane, the plate can be moved downwards relative to the image sources to allow for the next layer of curing to occur thereby sequentially forming the article. The plate can have a number of apertures disposed within it to allow for draining of the liquid resin. This process of printing can be called top-down printing. A wiper can be provided to move resin away from a printed 2D layer before the next layer is formed. Alternatively, a wiper could be used to apply a fresh layer of resin. This may be useful when printing objects with large flat region since a wiper may reduce the time needed to replenish the resin between polymerizing each layer. A wiper may also help to control the thickness of the resin prior to polymerization by ensuring that each layer, for example in non-continuous printing methods, may be of the same thickness.

The printing process can require the use of a relatively fast curing resin. In the uncured state the resin is sometimes referred to as a liquid resin. By liquid resin it is meant that the resin is flowable (not completely cured). It should be understood that references to “resin” alone are sometimes references to liquid resin, unless the context makes clear otherwise. When cured the resin can have a hardness of approximately 30, 35, 40 shore D. Some resins can have a cured hardness of approximately 70, 73, 75, 80 shore D. The hardness of the cured resin can depend upon the intended use of the finished printed article. For example, components for use in an automotive engine may require a greater hardness than components for use in the human body.

Resins that can be used in the 3D printing process can be those based on monomers of olefins, vinylics, acrylate, methacrylate, styrenes, although other monomers such as alkynes can be used. One or more resin monomers can be used to create a co-polymer, for example acrylonitrile-butadiene-styrene-based co-polymers. The monomers may contain two or more polymerisable group. The two or more polymerisable groups may be the same, or they may be different. For example, a monomer with two methacrylate moieties can be used, or a monomer with a methacrylate and a styrene group can be used. Monomers with two or more polymerisable groups are called crosslinking agents. Crosslinking agents can be included in the resin mixture to improve the resultant mechanical properties of the object created by the 3D printer.

Photo-activation, more commonly known as photo-polymerisation, occurs when the liquid resin is exposed to the light intensity from a lamp in an image source. The photo polymerisation is the curing of the resin. Whatever image source is used for photo-polymerisation, one or more wavelengths of the light produced should be the same or similar to those required to activate an initiator in the liquid resin to start the curing process. Alternatively, specific initiators can be included to match a specific wavelength of the image source. In one form, photo-activation can occur in a range of from about 200 nm to 450 nm. In one form photo-activation can in a range of from about 225 nm to 415 nm. Polymerisation may be carried out under an inert atmosphere e.g. nitrogen. Polymerisation may be carried out under an ambient atmosphere. The atmosphere required will depend upon the resin chemistry. For polymerisations carried out under an inert atmosphere, the resins may be purified to prior to polymerisation e.g. remove any dissolved gasses such as oxygen. If the intensity of the lamp is below that required for activation of the initiator, polymerisation may terminate. To prevent termination, one or more additional lamps may be included to increase the intensity of the light. Polymerisation can be additionally terminated by introducing terminating agents. Terminating agents can include radical scavengers such as molecular oxygen.

The liquid resin may be heated in the resin bath. The resin bath can be any vessel capable of holding the resin. There can be at least 3, 4, 5, 6 or 7 litres of resin in the bath. Larger baths can be used to make larger articles. Smaller baths can be used to make smaller articles. The heater can be attached to the resin bath to allow for the transfer of heat by induction or convection. The liquid resin can be heated to at least about 30, 40 or 50° C. The liquid resin can be maintained at the elevated temperature using a thermostat. The heater can have its own power supply so it does not influence any of the other electronics used in the system.

Heating the liquid resin may increase the rate of polymerisation (curing) of the resin. Heating the resin may also decrease the viscosity of the liquid resin. Decreasing the viscosity of the liquid resin may improve flow characteristics during the printing process. Improving the flow characteristics may be important for objects that contain portions that are substantially flat because the liquid resin can then flow over the cured surface as the plate is moved within the resin bath.

Objects that contain substantially flat regions require resin to be replaced above the object after each 2D layer is polymerised and the plate is moved downwards. Heating the resin to lower its viscosity may help to speed up resin replacement for regions that are substantially flat.

The printing process can be continuous which means that there can be no need to stop the printing process to allow for the resin to cure in one 2D layer before a second layer is printed. The plate within the resin bath can be moved continuously during the printing process. The continuous nature of the process may be due to multiple images projected onto the resin which have increased brightness and therefore increased energy for resin curing. The resin cures so quickly that the next image can be projected without delay. Continuous printing may be achieved by projecting separate images that can be combined to form a movie file onto the liquid resin. The speed at which the movie is played may be determined by the size of the projected images, the size of the article, the type of image source, and/or the resin(s) use.

During printing, there may be some areas of the article that lend itself to a is continuous printing process. There may also be some parts of the article that require non-continuous printing. In non-continuous printing, the image is projected, the resin cures and then the image is switched off (no image is projected). The plate can then be moved and then the next image is projected to a sequential 2D plane. Non-continuous printing may occur where there is a large flat surface that requires a significant amount of the resin to cure. A computer program can be written to instruct the printing process.

An article may be printed using both continuous and non-continuous printing. In these circumstances, a computer source, such as an image computer, can be used to instruct the image sources to project a movie for part(s) of the article that are printed using continuous printing and individual still images for part(s) of the article that are printed using non-continuous printing. The image computer may be used to control movement of the plate, or another computer, such as a plate computer, may be receive instructions from the image computer to control the plate.

The picture projected onto the resin is generated by the image sources. In some embodiments, the projected images are substantially the same and substantially overlap. In some embodiment, the projected images are different and are aligned so as to abut along the image edges. Each of the image sources contributes to a single image (or picture) that is projected onto the resin. The image sources can each be connected to an alignment system that precisely aligns the images generated from each of the sources into one single picture with amplified brightness. The image sources can first be aligned manually to align the images from each source to the extent possible with the human eye. This alignment process can be by moving each image source along an axis which can be a support to which the image source is attached. Once the images are overlapped as close as possible using the human eye, the electronic alignment system can be used. The image sources may include sensors that may inform the electronic alignment system the physical orientation of the image sources, and this may assist the electronic alignment system in aligning the images. For example, electromechanical devices and sensors, such as an encoder, a rotary encoder or stepper motor, may be used to inform the electronic alignment system the physical position of the image sources. Mechanical alignment may also comprise electrical means to move the image sources. As an example, a linear actuator, rack and pinion or similar that is controllable from a computer may mechanically align the image sources, and the information used to mechanically align the image source may be used to assist in electronic alignment. Because both mechanical and electronic alignment systems can be used, mechanical alignment may align the image from the sources to approximately at least 85, 90 or 95% alignment, with the remaining 5, or 10 or 15% being performed by electronic alignment. These percentages are exemplary only and mechanical alignment may account for more or less than 95%. The required percentage of mechanical alignment may be determined by the size of the projection area, the polymerization rate, and/or the design of the printed article. When DLP are used as the source, electronic alignment can be performed by the influence of a computer and/or computer program. The use of such a computer or program may ensure that the images are aligned with accuracy greater than about 98, 99 or 100%. Ensuring that the images are as closely aligned as possible may help to ensure that the printed article is printed as fast as possible and/or with optimal resolution.

The alignment system can also be used when parts of a whole image are projected from a plurality of image sources respectively. In such circumstances, alignment is not to ensure that the images are substantially overlapped, but may allow each of the images used to construct the final image to be positioned accurately on the 2D plane. By “accurately”, it is meant to mean greater than 98, 99 or 100%. An outer portion near the periphery of each image may be overlapped. Alternatively, the edges of adjacent images may abut one another so that there is no overlap between adjacent images. Relative to the number of pixels that make up the image, the overlapped portion may be a small percentage of the pixels in the image. The image sources may first be aligned by mechanical alignment and the electronic alignment may ensure that the pixels at a border of each image are abutted with or overlapped with the pixels of adjoining image(s). For example, a border around the image of 10 pixels wide may overlap with a similar border from the adjoining image(s). The relevant pixels are aligned, which means that the pixels at the edge of adjacent images are not aligned randomly, but in context with the complete image, so that the complete image is an accurate reflection of the image to be printed. The same computer or software for ensuring the images are is substantially overlapped and substantially aligned may also align the pixels at the border of each image, but a second computer and software may also control the border pixel alignment. The alignment system may reduce the intensity of the pixels that are overlapped such that the sum of the intensity of the overlapped pixels is substantially equal to the intensity of pixels that are not overlapped. For example, not overlapped pixels may have an intensity of 1 unit, and overlapped pixels may each have an intensity of 0.5 units, which when overlapped, combined to give a total intensity of 1 unit. This may help to ensure that the complete image has a substantially uniform intensity.

Where articles are printed using a plurality of image source units, the image source units can be mechanically and electronically aligned using the alignment methods already described, for example using a computer program and alignment of a pixel border or abutment of images, but so too can the image sources that make up the image source units. The image source unit and the image sources can be controlled independently of each other, in groups with each group being controlled independently, or in one group that controls all image sources and units. There may be one or more computers and programs to control the different alignment methods. Each image source unit and image sources can be controlled using mechanical and/or electronic methods. Mechanical methods may be manual or may involve the use of electromechanical devices/sensors that can allow automated mechanical methods. The automated mechanical methods may be controlled using the same computer(s) that control electronic alignment.

The size of the projected image can be any size, for example, at least about 50, 60 or 70 mm×about 30, 40, 50 mm (in any combination). The projected area (the area onto which the image is projected) may be significantly larger. In one embodiment the projection area is 68 mm×38 mm. The resolution of the printed article is dependent on the size of each pixel of the imaged projected onto the resin on the X/Y plane. For a HD image source, to print an article at a resolution of for example 35 microns, the sources need to be approximately twice as close to the resin compared to an article to be printed at a resolution of 70 microns, because the size of each pixel on the projected X/Y plane increases when the source is moved away from the X/Y projection plane. The size of the image sources may restrict the obtainable resolution, as two image sources may be sufficiently large to is prevent them from projecting images closed to the resin to allow for a resolution of less than for example 70 microns. A reduction in the size of the image sources may allow the resolution of the printed article to increase. The heat generated by the image sources may also determine how close the image sources can be to the resin because excess heat may prematurely polymerise the liquid resin. A cooling system may be provided to cool the image sources. A non HD DLP projector will likely allow a resolution of approximately 70 micron X/Y. A HD DLP will likely allow a resolution of approximately 35 micron X/Y.

The images projected to the liquid resin are intended to cure the resin within a single 2D plane. Polymerization of the liquid resin occurs at a 2D (X/Y) plane where the image is projected. To build up the article in the Z direction, either the projected 2D plane needs to move relative to a reference point on the article being printed, or the 2D plane is the reference point and the article is moved relative to it. For the 3D printer described herein, the article can be moved relative to a fixed 2D projection reference point. The movement can be effected by moving the plate located substantially in the liquid resin.

Without being bound by theory, it is thought that the light projected from the image source penetrates into the resin bath. The intensity of the light decreases as it penetrates further into the bath. Because of this, polymerisation typically occurs close to the top surface of the liquid resin where the light intensity is high enough to initiate polymerisation. The depth that the light is intense enough to initiate polymerisation is typically the depth polymerised for each image projected onto the surface of the resin, and can be called the penetration depth. The amount of material added to the printed article is dependent on the penetration depth. For example, a penetration depth of 35 μm would mean each image will add a layer 35 μm thick of material to the article. This penetration depth can be increased or decreased depending on the intensity of the lamps used to project the image, the type of resin used and/or the wavelength of the light emitted from the image source. Additives may also be added to the resin to absorb a portion of the light to control the depth the light penetrates into the resin. For example, pigments can be added to the resin to selectively absorb light and decrease the penetration depth. This may help to improve the resolution of the printed article.

The image as generated may have areas of high brightness or greater light intensity relative to other areas of the image. The areas of greater light intensity are most frequently at the centre of the image as projected; and areas of relatively less light intensity are typically at the peripheral edges of the image as projected. The area of greater light intensity at the centre of a projected image can be referred to as a hotspot. When there are images overlapping from multiple image sources, the hotspot at the centre of the image can be of greater intensity. It is desirable for the resin to cure at an even rate across the single 2D plane. A hotspot when projected onto a resin bath can cause accelerated resin curing in that spot while resin in other areas takes longer to cure. In order to compensate for the hotspots, there can be a hotspot compensation process undertaken before the printing process. The hotspot compensation process can allow the user to create any number of pixels having an intensity that can be changed by computer prior to the image being projected. This software instruction effectively becomes a mask over a normal image/layer so that the power of the middle of the image/layer can be reduced to the same intensity of the outer pixels. The hotspot compensation may additionally be used during overlap of adjacent images at a border.

The 3D printing system can comprise a computer, a resin bath that can be filled with liquid resin, the image sources, and the software for co-operating the components. The sources can be mounted to rails within a framework. The printer can connect directly to a PC which can feed in information

To print an article, a first image can be projected onto the liquid resin using the image sources. After a predetermined time, usually the time required for sufficient polymerization, the first image is no longer projected onto the resin. After this point, the plate can be moved down by a predetermined distance. The pre-determined distance can be determined, for example, by the shape of the article being printed, the size of the projected image, the type of resin, the intensity of the projected image and/or a computer program. Once the plate has moved down by the pre-determined distance, a second image is projected onto the liquid resin using the image sources. This process of projecting images and moving the plate down is repeated until the final article is printed. In this regard, the printing process can be considered as adding sequential layers of the article on top of one another until the final article is printed. The images projected from the image sources and/or image source units may form part of an animation (i.e. movie) with there being no perceivable gap between when the various images that make up the animation. The movie can be projected onto a fixed plane in the 2D resin, or the movie can move across the 2D plane as it is projected. The advantage of the latter is that a larger area of resin can be cured in a single 2D plane using the image sources. Movement of the plate and projecting the images may be done in such a way that the plate continuously moves as the images are projected as an animation.

Also described herein is the idea of a system of controlling a 3D printer. As already mentioned there may be any number of computer programs that interface with the printer for printing an article. By computer program, it is meant computer, computer program, programmable logic controller and/or program, and the terms may be used interchangeably throughout. Additionally, the term “computer program” may include a plurality of programs designed to perform a specific task. In such a system, there may be a central computer program that interfaces with any number of computer programs that control each individual process of the printer, for example one for each plate control and image source control. For example, a digital image of an article to be printed is fed into the central computer, then the computer programs responsible for controlling the plate can ensure the plate is in an initial starting position. Alternatively the plate can be manually moved to the initial staring position. At the same time, the central computer program can interface with an image source computer program to determine which image source projects what image. Electronic alignment of the images can be performed by a central computer program and/or the image source computer. Alternatively, a separate computer program can be used to align the images. The image sources may be mechanically and/or electronically aligned so that the images from the image sources can be moved relative to the 2D plane. The images from the image sources can in this way be overlapped or aligned to form a larger image. The images might contain an image that contains a single pixel through to filling the full plate.

Once each of the computer programs responsible for each process is ready to print an article, they can communicate with the central computer program to request further instructions. From there, the image source computer program and the plate computer program can display images and move the plate in a synchronized manner to print an article. For example, once an image is projected onto the resin for a predetermined time interval and the liquid resin has solidified, the system can send instructions to the plate computer program to move the plate by a predetermined distance, and once the plate has moved, the system can send instructions to the image source computer program to project the next image in the sequence. However, this type of system may not always be needed. In another example, instructions may be sent only one time to move the plate from a starting point to an end point and the images may be displayed as an animation once the plate has moved from its starting point. This type of arrangement may involve less processing and may lead to faster printing times a smoother printing process. The speed of the plate movement and the speed of the animation may be determined by the operation parameters, for example the size and/or shapes of the article being printed. The different computers programs may communicate with each other directly and/or through the central computer program. Other computers programs may also interface with any one of the central, image and plate computers/programs, such as a computer program used to control the temperature of the liquid resin.

The digital image of the article to be printed can be provided from an additional computer/program. An article can be constructed entirely from any suitable computer program to form a digital article file. Programs to construct such a file might include, for example, AutoCAD and SolidWorks. A digital article file can be generated from a physical object that is scanned and rendered into a digital file. This digital file can then manipulated using any suitable program. Regardless of the route used to generate the digital article file, it can then be fed into the central computer program and the operation parameters required to print the article can be determined. The parameters may be determined automatically and/or or they may be determined by an operator. In some forms, the file containing the image to be printed may contain all the information necessary to print the article when the file is sent to the image source. When a plurality of sub-image images are projected from a plurality of image sources and/or image source units, the file may be broken up into sub-files, for example using a computer connected to the image sources, then sent to respective image sources, for example when sub-images are used to print an article. Alternatively, a plurality of sub-files may be first generated using a program that can construct the file containing the image to be printed, then the plurality of sub-files can then be sent to a plurality of respective image source to project a plurality of sub-images to form the complete image once the plurality of image sources projects the plurality of sub-images. Breaking the complete file into sub-files may involve less processing and may lead to faster printing times a smoother printing process. Alternatively, the images may be generated on the fly during the printing process.

When the article is completed the image sources and/or plate can be mechanically and/or electronically moved before unloading the printed article. If automated image sources are installed, the system can send instructions to the image sources to move out of the way after the last image is uploaded and the time for last portion of the resin to solidified lapses. The system can also send instructions to the article plate program to move up so that the item can be removed. When the printer does not have automated image sources installed the user may need to move the image sources out of the way before unloading the item. This type of plate and/or image source movement may also occur when switching between continuous and non-continuous printing.

According to another aspect of the invention there is provided a system for 3D printing an article, the system comprising
an image computer to provide an image to one or more image sources that project the image onto a liquid resin in a single 2D plane wherein the images from the image sources are at least partially overlap at least in the single 2D plane in the liquid resin;
an image source computer to control the distance from the one or more image sources to the 2D plane;
a plate computer to control a plate that is movable substantially perpendicular relative to the 2D plane;
wherein the image computer, image source computer and the plate computer cooperate to allow the projected images to cure the liquid resin.

The invention also provides in another aspect an apparatus for 3D printing an article comprising:
a first image source that projects a first image onto a liquid resin;
a second image source that projects a second image onto the liquid resin, wherein in use the images from the first and second sources at least partially overlap at least in a single 2D plane in the liquid resin; and
a plate located in the liquid resin and that is continuously movable in a direction substantially perpendicular relative to the 2D plane.

The invention also provides in yet a further aspect articles printed by the method, system and/or the apparatus of the invention.

### BRIEF DESCRIPTION OF THE FIGURES

Embodiments of the invention will now be described with reference to the accompanying drawings which are not drawn to scale and which are exemplary only and in which:

FIG. 1 shows a perspective view of a 3D printer;

FIG. 2 shows a perspective view of the first image source with associated mounting bracket;

FIG. 3 shows a perspective view of the second image source with associated mounting bracket;

FIG. 4 shows a perspective view of the plate.

FIG. 5 shows one image projected from two projectors.

FIG. 6 shows two different images bring projected to form a larger image.

FIG. 7A to 7E show different embodiments of systems that control the 3D printer.

FIG. 8 shows a side view of an embodiment of a printer.

FIG. 9 shows a side view of an embodiment of a printer.

FIG. 10 shows a side view of an embodiment of a printer.

FIG. 11 shows an embodiment of image source units projecting images onto a 2D plane.

FIG. 12 shows an embodiment of image sources projecting an image onto a 2D plane.

FIG. 13 shows an embodiment of image sources projecting an image onto a 2D plane.

### DETAILED DESCRIPTION OF EMBODIMENTS OF THE INVENTION

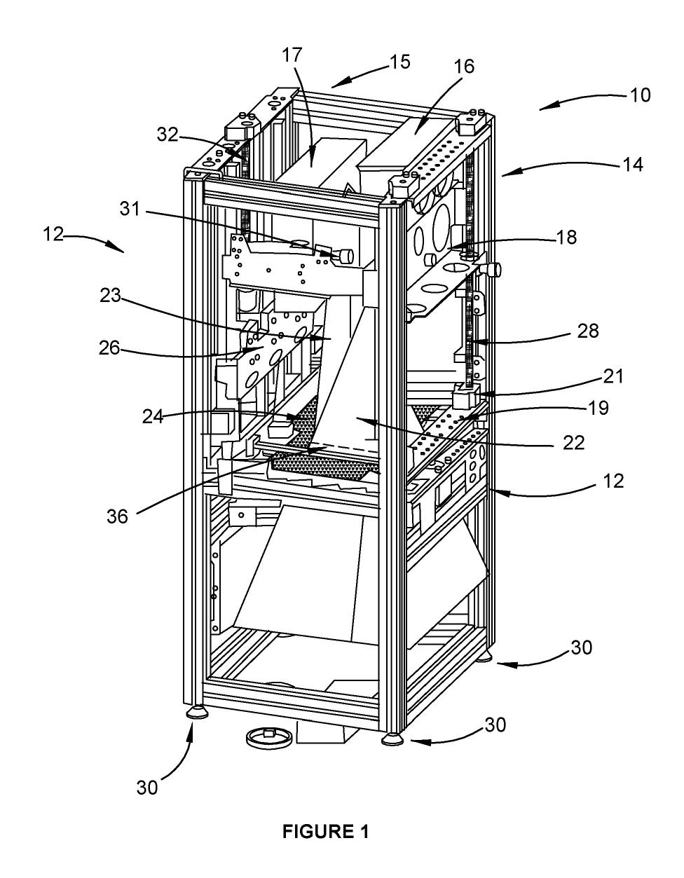

A 3D printer 10 is shown in FIG. 1. The printer 10 is made from a frame 12 that has vertical supports 14 and horizontal supports 15 to define a hollow supporting structure. The length of the vertical supports 14 are longer than the length of the horizontal supports 15. However, as should be appreciated, the length of the vertical and horizontal supports may be of any length, and the length may be determined by the size of the article being printed. The vertical supports 14 and horizontal supports 15 can be made from any material suitable to construct such a frame. In an embodiment, the supports are made from aluminum. In an embodiment, the supports are made from a plastic and/or fibre reinforced plastic. Located at the base of the frame 12 are feet 30. The feet 30 are individually adjustable to allow the article plate 24 to be substantially level. However, other levelling means known in the art can also be used to level the printer 10, for example, hydraulic or air cushions and so on.

In one form, each foot 30 is individually controlled by way of electromechanical sensors to determine the level of the printer 10. If the printer 10 becomes un-level, the electrometrical sensors instruct a computer controlling the feet 30 (not shown) to level the printer 10. The feet 30 may be adjusted during printing and/or before printing commences. The computer controlling the feet 30 may communicate with other computers associated with the printer 10.

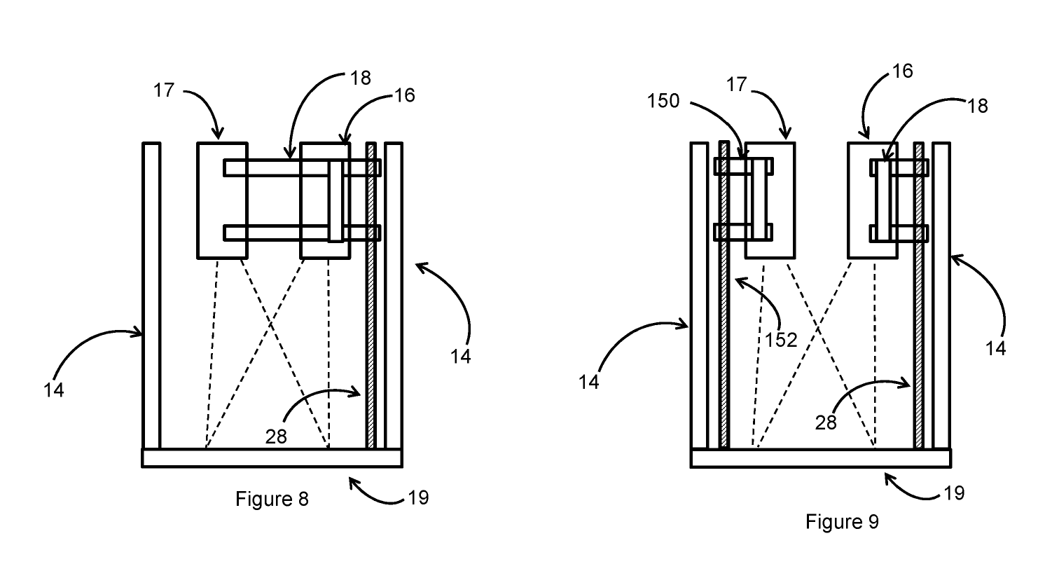

Attached to the frame 12 are image sources in the form of a front projector 16 and a back projector 17. The front projector 16 is fixed to a projector fixing plate 18 located on the back projector 17. In this arrangement, as shown more clearly in FIG. 8, the front projector 16 and back projector 17 move together along a longitudinal axis of the vertical supports 14 by way of a linear projector actuator 28 engaging with the projector fixing plate 18, allowing the projectors 16 and 17 to move relative to a base bar 19. The actuator is moved by a projector motor (not shown). In another form, as shown in FIG. 9, the front projector 16 has its own is fixing plate 18 and linear projector actuator 28 that is separate from the rear projector 17 which has its own projector plate 150 and linear projector actuator 152. This arrangement can allow separate movement of the projectors 16 and 17. Movement of the projectors can be automatically controlled or manually controlled. In the case of manual control, the actuator can be replaced and the projectors can move along and engage with a slide that runs along the longitudinal axis of the vertical supports 14. A retainer 21 located on the base bar 19 holds an end of the projector actuator 28. The projector motor may be housed in the retainer 21. The projector motor can be connected to electromechanical sensors to provide electronic feedback as to the physical location of the projectors 16 and 17. In this embodiment projectors are shown schematically, however, the fixing plate 18 and/or 150, and linear actuators 20 and/or 152 can be arranged to house and move any type of image source, such as DLP projector, LCD and/or LED displays and UV lamps.

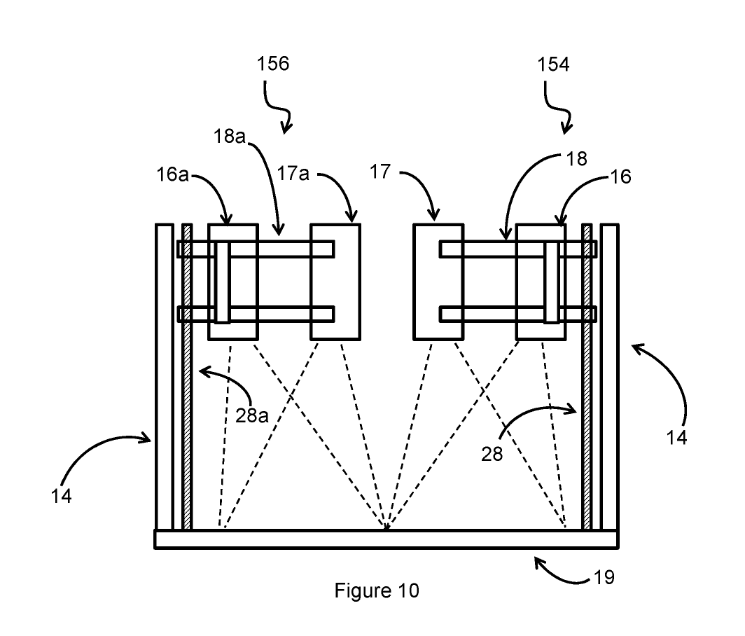

Although projectors 16 and 17 in some forms are fixed to one another and move linearly along a longitudinal axis of the supports 14, they can be controlled independently relative to one another by using, for example, a second actuator (not shown). The second actuator may allow the spacing between the projectors 16 and 17 to be adjusted. For example, the front 16 and rear 17 projectors can be connected to frame 18 and/or 150 by way of an actuator that allows the spacing between the projectors to be adjusted. For printers that have more than two projectors, the projectors can be mounted and moved as a unit, such as shown in FIG. 8. Alternatively, the projectors may be each moved individually by, for example, an actuator for each projector, such as shown in FIG. 9. In some embodiments, the projectors can be grouped into two or more units with each unit being controlled by a separate actuator, as shown in FIG. 10 where the first unit 154 has a projectors 16 and 17 connected to plate 18 and that is moveable along actuator 28, and a second unit 156 has projectors 16a and 17a this is moveable along actuator 28a. In FIGS. 8 to 10, exemplary overlapping and/or abutting images projected from the image sources in the form of projectors are represented by way of dashed lines. The relative position of the projectors along an axis defined by the supports 15 can also be adjusted by manual or automatic means. For example, the printer 10 could have 16 projectors to print an article such as a car. In this circumstance, it may be desirable to move each projector and/or units of projectors independently of each other along an axis defined by the supports 15. This may help to align the images. It may also allow the same printer to print articles of varying size, for example small articles such as jewelry and large articles such as car doors, by simply reorganising the projectors. For example, in the embodiment in FIG. 10, each projector 16, 16a, 17 and 17a is attached to respective frames 18 and 18a by a projector adjustment means configured to adjust the relative spacing between the projectors. The projector adjustment means may be automatically controlled by way of electronically controlled actuators or be manually controlled.

A first projection 22 from the front projector 16 and a second projection 23 from the back projector 17 are angled so that they are substantially overlapped at a 2D projection plane 36 located near the plate 24 adjacent to the base bar 19. The angle could be obtained by angling the images 22 and 23 and/or the projectors 16 and 17. It should be appreciated, however, that the angle required to overlap the two images is dependent on the distance from the projectors 16 and 17 to the base bar 19. For example, increasing the base plate-projector distance decreases the angle. The front and/or back projector can be mechanically adjusted by way of an adjustment mechanism 31 to allow the projected images to be substantially overlapped. The adjustment mechanism 31 in some forms is the projector adjustment means configured to adjust the relative spacing between the projectors. The projections 22 and 23 can further be overlapped by adjusting the position of the images by electronic means (not shown). The electronic means is related to the software that projects the images. For example, internal components of a DLP projector can be instructed by software to adjust the position of the image.

As mentioned previously, the printer 10 can be levelled using the feet 30. Although it is desirable for the printer 10 to be level, it may not always be critical during printing of articles. The projection plane 36 is aligned perpendicular relative to the longitudinal direction of the projections 22 and 23, and the liquid resin in the bath (not shown) is substantially parallel to the projection plane 36. Therefore, so long as the projectors are correctly aligned, the printed article should not be affected by the level of the printer 10. The person skilled in the art would appreciate this operational aspect of the printer 10. The projector adjustment means along with the projector actuator 28/28a can be used to control the alignment of the projectors so that the projector plane 36 is maintained in the same position during printing. If the projection plane 36 moves during printing, the projector adjustment means adjusts the projectors so that the projected images 22 and 23 are correctly aligned. Sensors may be provided to determine how aligned the projected images 22 and 23 are, and whether the image at the projection plane 36 is correctly aligned. For sake of clarity, some features from the printer 10 have been omitted in FIGS. 8 to 10. It should be noted that images are aligned relative to one another and not necessarily to a fixed located on the plate 24 and/or printer 10. However, in some embodiments the images are aligned relative to one another but so they are positioned relative to a fixed located, for example the middle of the article plate 24.

Also attached to the frame 12 is a plate in the form of an article plate 24. An article plate 24 is attached approximately perpendicular to the article plate bracket 26. The article plate bracket 26 engages with a plate actuator 32 to allow the article plate 24 to move in a longitudinal direction relative to the vertical supports 14. The plate actuator is controlled by a plate motor (not shown).The position of the article plate 24 in FIG. 1 is also approximately the position of the projection plane 36 located at the surface of the resin bath (not shown). As mentioned previously, the 2D projection plane 36 is the plane where liquid resin is polymerised to add material to the article. Additionally, the article plate 24 shown in FIG. 1 is in an upper position, but when an article is being printed, the article plate 24 moves away from the projection plane 36. The speed at which the article plate 24 moves with an article is being printed can depend on for example the intensity of the light emitted by the projectors, the size of the article being printed, the speed of printing, whether continuous or non-continuous printing methods are used, and the resolution required. In some forms, the article plate 24 is additionally configured to move perpendicularly to the vertical supports 14. This can be useful when the article plate 24 is significantly smaller than the resin bath and an article that has a size approximately similar to the resin bath needs to be printed. To move the article plate 24 perpendicularly to the vertical supports 14, the plate bracket 26 is fitted with one or more linear actuators that allow the plate 24 to move in a 2D plane. Any instructions to move the plate in a 2D plane would be in communication with the image(s) being projected onto the projection plane 36 to ensure that the images remain aligned to the article being printed.

The projector motor and plate motor can be controlled independently by different computers, or they may be controlled independently by the same computer. The computers may be internal or external to the printer 10. Although not shown, one or more computers provide the images for the projectors 16 and 17. Regardless of how many computers are used to operate the printer 10, they can all communicate with each other to determine the optimal printing conditions. For example, the projector computer may provide images to the projectors 15 and 17, and in combination with the computer that controls the projector motor, instructs the computer that controls the plate motor the speed at which the plate is to be moved during printing.

The embodiment shown in FIG. 1 coverings (not shown) may be applied to one or more faces of the printer 10. The coverings may provide protection for the components that make up printer 10 and/or may provide the printer 10 with suitable aesthetics. The coverings may have access ports such as doors to allow access to internal components such as projectors 16 and 17 and/or to access an article on the projection plane 36. An access point such as a hinged door to access the projection plate 36 may be made of a transparent material so that an operator can easily inspect an article being printed. In embodiments where image source(s) emits potentially harmful wavelengths, such as UV radiation from a UV lamp, additives may be included in the transparent material to prevent the harmful wavelengths from travelling therethrough. Perspex-based materials may be used to adsorb UV radiation.

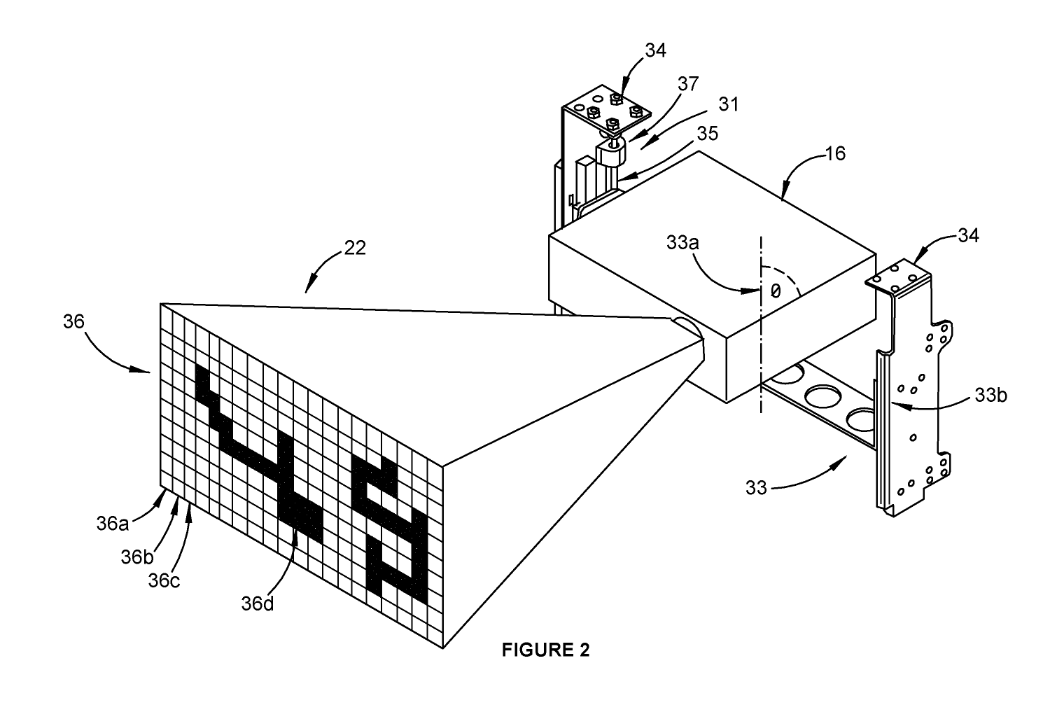

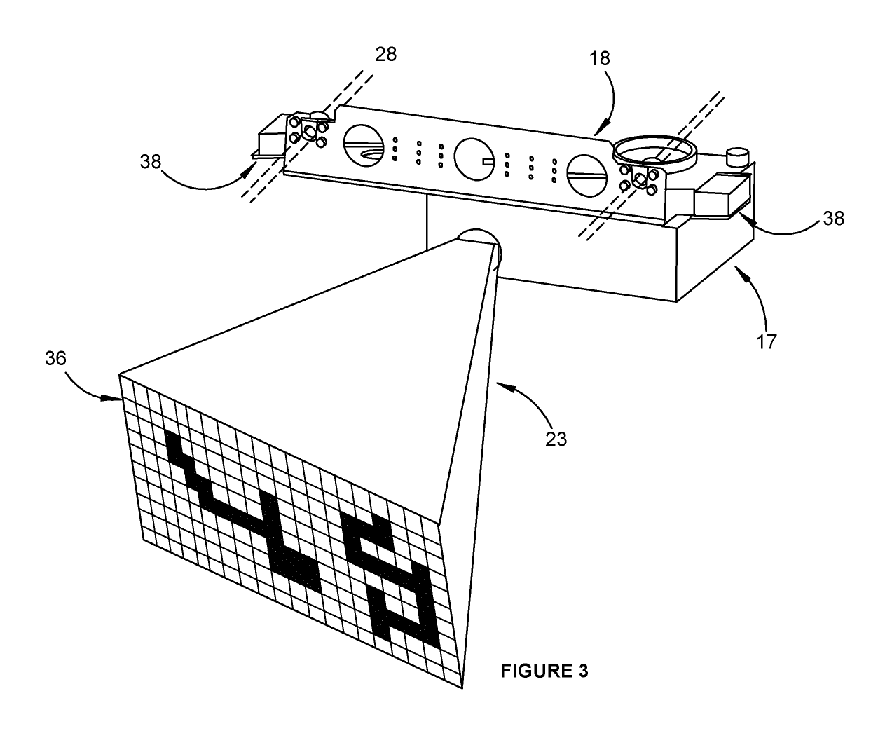

FIGS. 2 and 3 are close up representations of the front projector 16 and back projectors 17, respectively. The front projector 16 is attached to a front projector bracket 33. The front projector plate 33 has a flange 34 that is adapted to be fixedly attached to mounting brackets 30 located on the projector fixing plate 18. The adjustment mechanism 31 shown in FIG. 2 is in the form of rod 25 that is releasable fixed by fixing portion 37. By adjusting the position of the rod 35, an angle θ relative to the projector 16 and vertical axis 33a defined by the projector plate side wall 33b can be adjusted. In an embodiment, the front projector 16 and rear projector 17 can have additional adjusting means to help align the images. The adjusting means can be manual or automatic and would be known to the person skilled in the art. For automatic adjustment, electromechanical devices and sensors are provide in some embodiments so that the physical location of the projectors is communicatable to software controlling the projectors. In addition, in embodiments where there are more than two projectors, each projector can have the adjusting means mentioned above. Although not shown in FIG. 3, the back projector 17 can also be adjusted using a similar mechanism to that described in relation to FIG. 2. The projector actuator 28 is represented in FIG. 3 by way of dashed lines.

Exemplary images 22 and 23 are projected from the front projector 16 and back projector 17, respectively. In FIG. 2, at the projection plane 36 of the image 22 are individual pixels 36a, 36b, 36c and so on. The size of these pixels is exemplary only and in practice is determined by the resolution of the projector 16 and the distance of the projector 16 from the 2D projection plane 36. Further, for illustration purposed only, an image is shown at the projection plane 36 by way of darkened pixels 36d. The images from the projectors 16 and 17 are substantially similar, but there may be slight variations by electronic alignment and/or computer programs to accommodate the differences in the orientation of the projectors 16 and 17. As the article plate 24 moves away from the projection plane 36, the image at the projection plane 36 changes. The duration that each image is displayed is determined, for example, by the size of the image, the intensity of the projectors, whether continuous or non-continuous printing is used, the speed at which the article plate is moved and the resin(s) used. It should also be appreciated that the size of the pixels at the projection plane 36 determines, in part, the resolution of the features of the printed article. For example, if the size of the pixels are 35 microns, then the resolution of the printed article from a single projector is 35 microns. The embodiments shown in FIGS. 2 and 3 show projected images 22 and 23 which are intended to be substantially overlapped, but the projected images can also be aligned to abut at image edges or to have a border along the part image edge that overlaps with an adjacent part image.

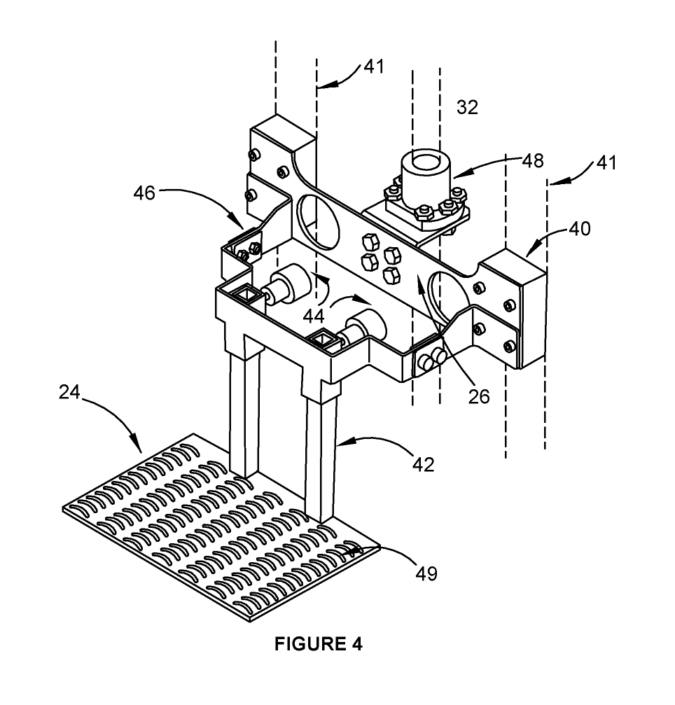

A close up of the article plate 24 is shown in FIG. 4. The article plate 24 is attached to the article plate bracket 26 by way of adjustment tubes 42 that reversible engage with a screw clamps 44, and the screw clamps 44 are positioned away from the article plate bracket 26 through separation supports 46. In an alternative form, the screw clamp is a locking pin that engages with apertures in the adjustment tubes 42. In some forms, the tubes are secured to the supports 46 so that the plate 24 remains fixed relative to the supports. A plate engaging portion 48 to engage with the plate actuator 32 (shown by dashed lines) is located on the article plate bracket 26 opposite the article plate 24. In the embodiment shown in FIG. 4, the plate engaging portion 48 is an aperture with a thread disposed on an inner wall defining the aperture that can engage with a thread of the actuator 32.

Rotation of the actuator 32 by way of the plate motor, such as a servomotor or stepper motor causes the tread on the actuator 32 to engage with the thread of the aperture, which causes the plate bracket 26 and in turn article plate 24 to move in a linear direction relative to the actuator 32. Alternatively, the plate engaging portion 48 may be a pinion and the actuator 32 may be a rack, and movement of the pinion by way of a motor moves the plate bracket 26 and article plate 24. In another form, the plate engaging portion 48 is a stepper motor and servomotor or equivalent electromechanical device that engages with the actuator 32 which is in the form of a linear member, such as a threaded rod, that allows the plate bracket 26 and article plate 24 to move along the longitudinal direction of the linear member. The linear actuator 32 may be a hydraulic ram where one end of the ram is attached to the plate bracket 26 at engaging portion 48 and another end is attached to the printer 10. Hydraulic rams may be useful when the article to be printed is heavy, for example a car.

Engagement of the plate engaging portion 48 and plate actuator 32 allows the article plate 24 to move in a longitudinal direction perpendicular to the article plate 24. Support blocks 40 are provided adjacent to the engaging portion 48 to ensure the article plate 24 does not move in an axis parallel to the projection plane 36 when the article plate 24 is moved in a Z direction from the plate actuator 32 during printing. The support blocks 40 prevent movement of the article plate in an X/Y direction by camming against a cam surface 41. In an alternative form, blocks 30 and cam surface 41 are provided as linear motion bearings. Although not shown in FIG. 4, the article plate 24 is initially just immersed at a top surface of a bath of liquid resin. As an article is being printed, the article plate 24 moves further into the resin bath below the surface of the bath in a Z direction. However, the direction of movement of the article plate 24 relative to the surface of the bath is determined by the orientation of the projectors. The orientation of the article plate arrangement shown in FIG. 4 is specific to the embodiments described herein, but the person skilled in the art would recognise that a plate that provides similar features to the one described here may have a different orientation and that this orientation can be determined by the overall design of the printer.

The article plate 24 shown in FIG. 4 has a plurality of apertures 49. The apertures 49 are included in the plate to allow liquid resin to flow through the article plate when the article plate 24 is moved by the actuator 32 during printing. Allowing the resin to flow through the article plate 24 can help to reduce unwanted fluid dynamics that may hinder the printing process, for example uneven fluid levels at the projection plane. Although crescent shapes are shown in FIG. 4, the apertures may take on any form. The size of the apertures can be determined by the resin type, the viscosity of the resin, the speed required for printing and/or the size of the article being printed. In some embodiments, when small article plates are used, the apertures may not be needed to allow for resin flow. Generally, the aperture size and shape is selected so as to reduce unwanted fluid dynamics that would hinder the printing process.

It should be appreciated that in the embodiments described, the images from each projector are substantially similar and substantially overlapped at the 2D plane.

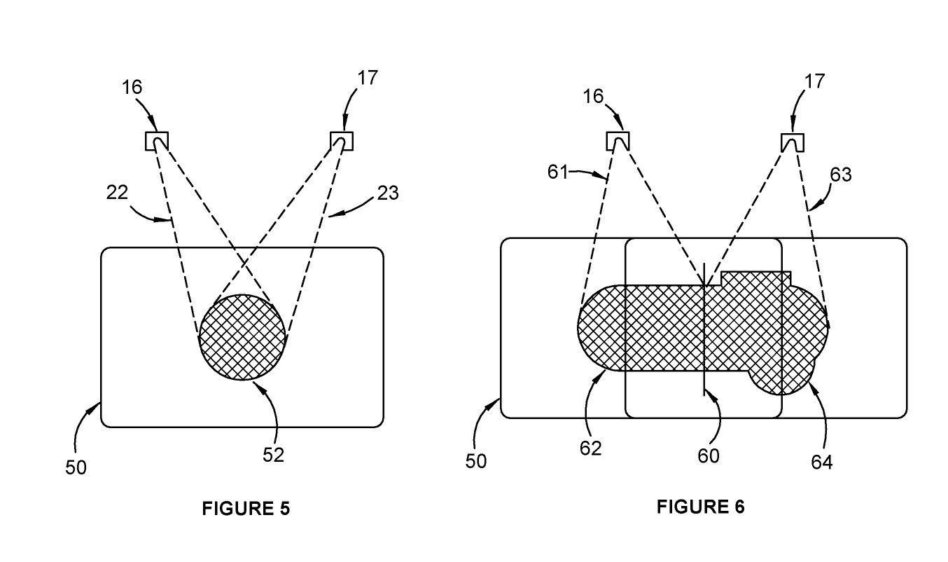

Schematically, this is represented in FIG. 5, where the front projector 16 and the back projector 17 project images 22 and 23, respectively. The images 22 and 23 are almost identical and are overlapped onto a 2D plane 50 to form a single image 52. However, the images do not need to be identical and overlapped to form a printed article. As shown in FIG. 6, the front projector 16 can project a first image 61 with a first shape 62 onto the 2D plane 50, and the back projector 17 can project a second image 63 with a second shape 64 onto the 2D plane. The images in FIG. 6 are not identical and are not completely overlapped, but instead, the images 62 and 64 are at least partially overlapped by being joined at the intersect 60 to form one image. To ensure the image is complete, there may be partial overlap of the images 62 and 64 immediately either side of the intersect 60. The overlap may be determined by a computer program. The advantage of this type of arrangement is that the two printers in FIGS. 5 and 6 can print a variety of articles with various sizes. In some forms, the first image 61 and the second image 63 projects shapes 62 and 64 so that the edges of the images defined by intersect 60 abut one another. In this way, a pixel line defining an edge of shape 62 is aligned so as to be positioned directly next a pixel line defining an edge of shape 64, where the join of the two pixel edges forms intersect 60. It is also possible to have more than two projectors projecting an image that is a combination of those shown in FIGS. 5 and 6. For example, there can be four projectors that have a first group with two projectors that project the first shape 62 and a second group that has two projectors that project the second shape 64. The first group can project a first substantially similar and substantially overlapped image, and the second group can project a first substantially similar and substantially overlapped image (e.g. FIG. 5), and the images from each group can then be combined to form a larger image (e.g. FIG. 6). If the image sources are adjusted by an angle θ, software associate with providing the image(s) to the image sources can in some embodiments provide an angle compensation so that the complete image projected at the 2D plane 36 is not affected by the angle θ.

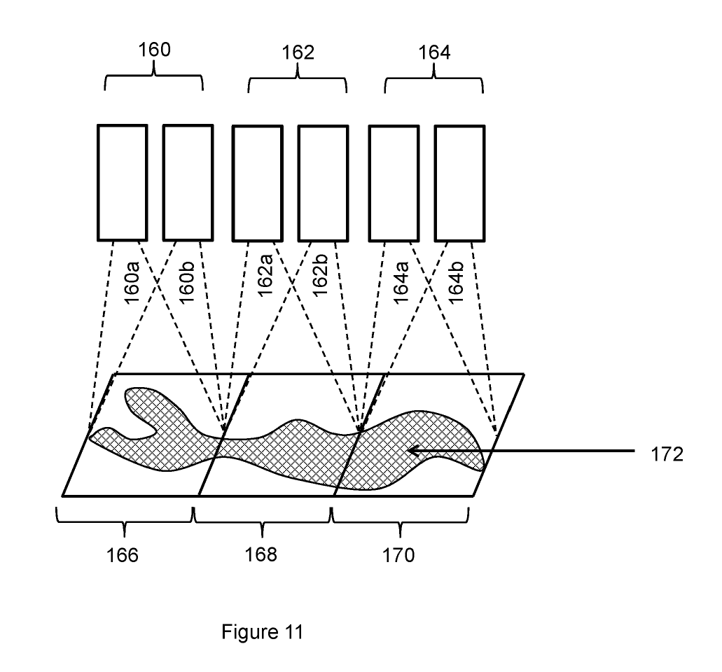

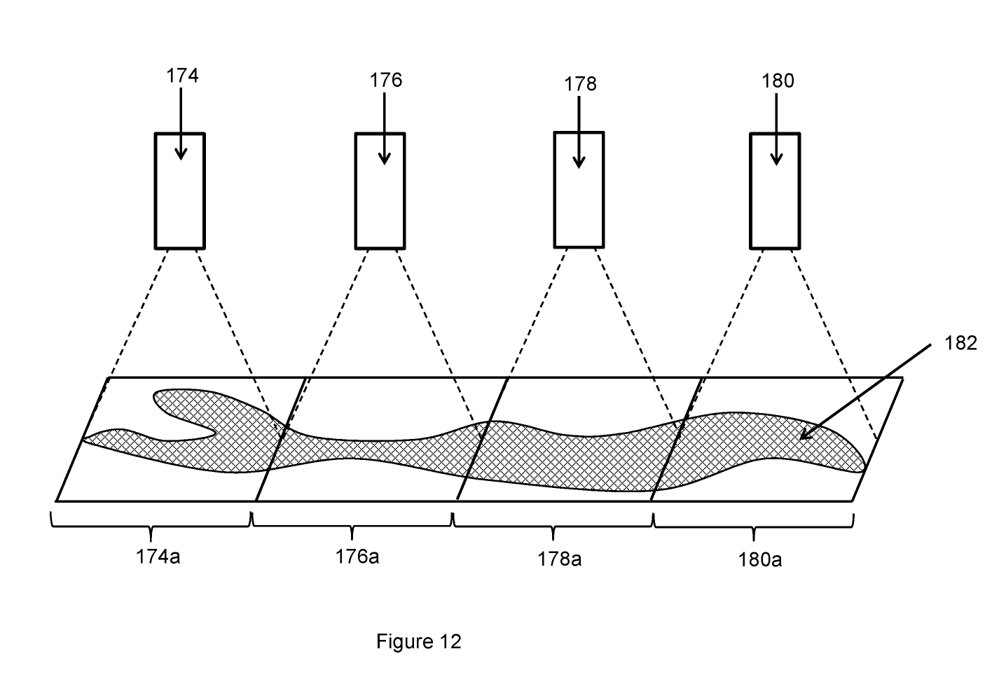

Any number of projectors can be used to project any number of images, such as 100+ projectors projecting 100+ images to form an image. This may make the printer 10 modular and scalable depending on the size of the article to be printed. The any number of projectors may be provided as image source units or as individual image sources. In the embodiment shown in FIG. 11, six image sources in the form of projectors are formed as three projector groups 160, 162 and 164. Group 160 projects images 160a, 160b, group 162 projects images 162a, 162b, and projector 164 projects images 164a, 164b, The images from each group are substantially overlapped to form three separate sub-images 166, 168 and 170 that are combined to form a complete image 172. In this way, an image is formed by both substantially overlapping two images to form a sub-image, and abutting or overlapping a border of adjacent images to form a complete image. In the embodiment shown in FIG. 12, four projectors 174, 176, 178 and 180 project is sub-images images 174a, 176a, 178a and 180a, respectively. The images abut or have a border that overlaps with adjacent images to form a complete image 182.

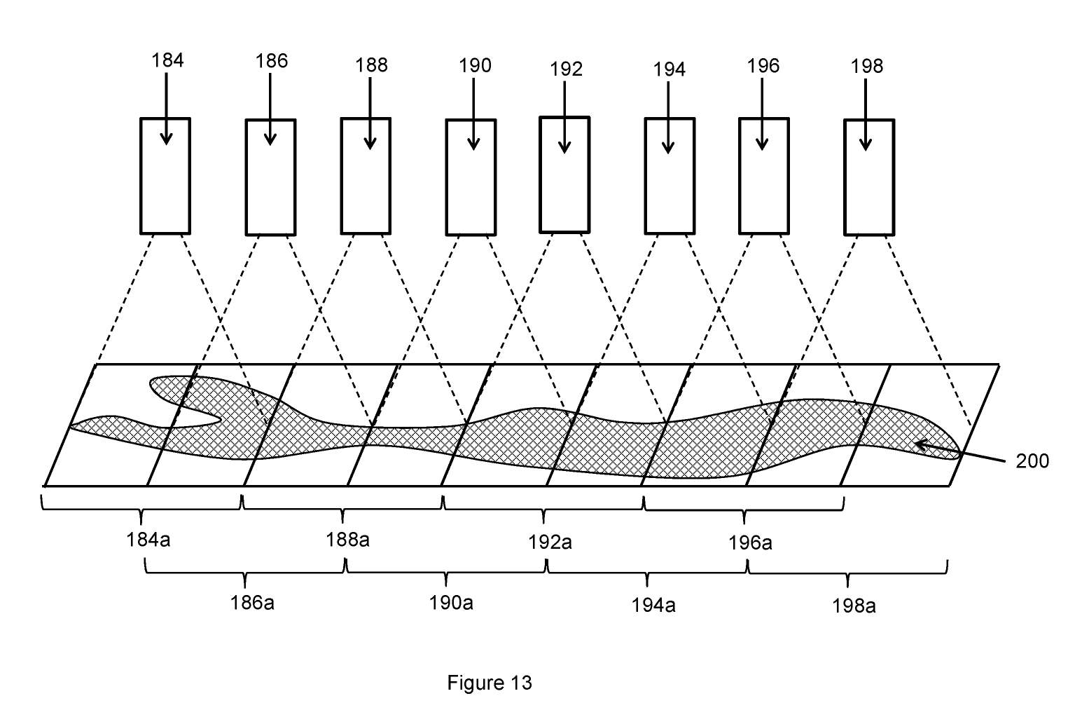

FIG. 13 shows another arrangement where individual projectors 184 through to 198 project images 184a through to 198a, respectively. However, in this embodiment, the images of each projector are substantially overlapped to form the complete image 200. In this way, the embodiment of FIG. 13 could be considered a hybrid of the embodiments shown in FIGS. 11 and 12. Software associated with the projectors ensures that the sub-images that make up the complete image 200 are substantially aligned so as to give a continuous complete image. Since images 184a and 198a each have approximately half their respective images not overlapped with an adjacent image, compensation for the image brightness and/or intensity may be used to ensure that the intensity of the complete image 200 is substantially uniform so that polymerization of the resin is approximately contestant across the complete image 200.

It should be appreciated that the embodiments shown in FIGS. 11 to 13 are side views and that the printer 10 may have an number of image source units in the X/Y direction. Further, some features from the printer 10 have been omitted from FIGS. 11 to 13 for clarity only.

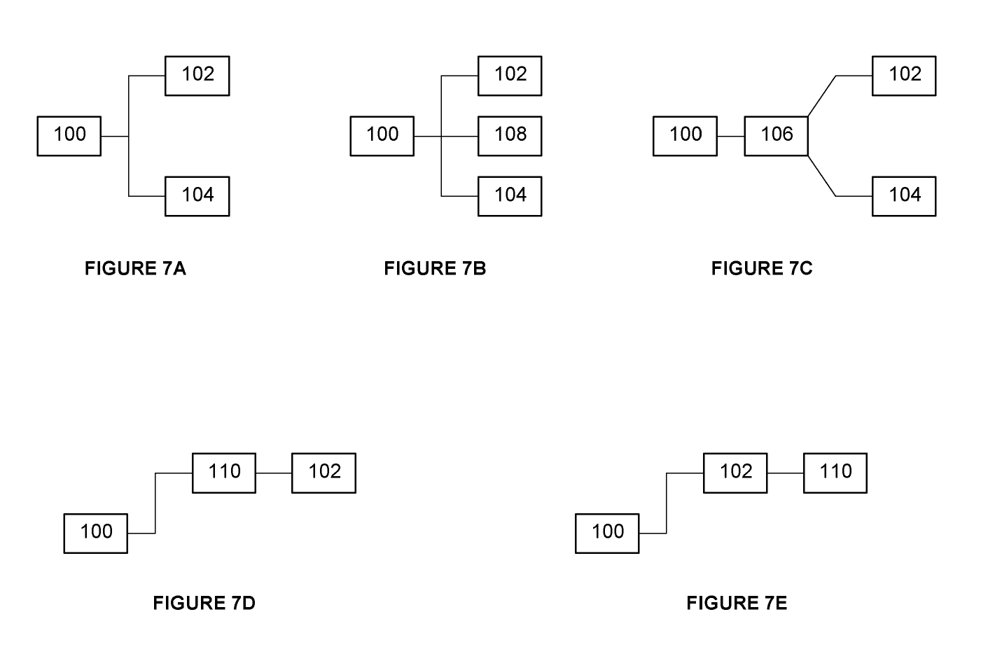

An embodiment of a system to control the printer 10 can be seen in FIG. 7A. Here a central computer program 100 can instruct a projector computer program 102 to for example align and display images and instruct an article plate computer program 104 to move the article plate 24 in synchronization with the projected images 22 and 23. In this embodiment, the central computer program 100 instructs when the projector computer program 102 and article plate computer program 104 can operate and with what parameters. However, the article plate program 104 can communicate directly with the projector program 102 and bypass the central program 100. The central program 100 can determine what type of communication is allowed, and this communication may be determined by the initial operational parameters. When an addition computer program, such as a liquid resin bath heater program 108 is used to print an article, as shown in FIG. 7B, the heater computer program 108 can communicate between the computer programs 102 and 104 using any of the above communication methods.

In another embodiment, as shown in FIG. 7C, a control step 106 prevents the projector program 102 from communicating directly with the article plate program 104. In this embodiment, the central program 100 instructs the controller program 106 when the steps 102 and 104 are allowed, and it is the responsibility of the controller step 106 to facilitate this. This type of communication may be useful when, for example, sensors relating to the level of the printer 10 inform controller program 106 that the printer is no longer level. The controller program 106 will then stop steps 102 and 104, instruct programs to level the printer, then recomments steps 102 and 104.

There may be additional computer programs associated with any of the other already mentioned computer programs. For example, as shown in FIG. 7D, an alignment computer program 110 is associated with the projector program 102. Instructions from the main computer 100 may be first received by the alignment computer program 110, and then the instructions are sent to the projector program 102. Alternatively, as shown in FIG. 7E, the alignment computer program 110 may receive instructions from the projector computer program 102. In some embodiments, however, the alignment computer program 110 and the projector computer program 102 may be one of the same computer programs. For the sake of clarity, other components of the system depicted in FIGS. 7D and 7E are omitted, but any of the other components already described can be present in the system. It should be appreciated that any computer program not already discussed that can be used to control the printer 10 can be included in the system using any of the disclosed communication methods.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood to persons skilled in the art of the invention that many modifications may be made without departing from the spirit and scope of the invention.

1-20. (canceled)

21. A method of 3D printing an article comprising the steps of
projecting images onto a liquid resin from a plurality of cooperating image sources;
during projection of the images: aligning the images at least in a single 2D plane in the liquid resin to ensure either the images are aligned to abut one another without any overlap, or that the images are aligned and at least partially overlap,
wherein the alignment is undertaken by mechanically adjusting at least one of the image sources to align the images by human eye; and then by electronically adjusting the projection of at least one of the projected images; and
moving a plate relative to the 2D plane;
allowing the liquid resin to cure upon expose to the image in the 2D plane, thereby forming the printed article.

22. The method according to claim 21, wherein there are at least first and second image sources, wherein each of the image sources projects an image that is substantially the same and the images projected from each source substantially overlap at least in a single 2D plane in the liquid resin.

23. The method according to claim 21 wherein there are at least first and second image sources, wherein the images projected from each of the first and second image sources are substantially different but at least partially overlap with one another once projected.

24. The method according to claim 21, wherein there are at least first and second image sources, wherein the images projected from each of the first and second image sources are substantially different and do not overlap with one another once projected.

25. The method according to claim 21, wherein the first and/or second image source comprises at least one Digital Light Projector.

26. The method according to claim 21, wherein the liquid resin is housed in a bath.

27. The method according to claim 26, wherein the bath comprises a heater to maintain the resin above ambient temperatures.

28. The method according to claim 21, wherein the mechanical processes overlap the images to an accuracy of greater than 85%.

29. The method according to claim 28, wherein the mechanical processes overlap the images to an accuracy of greater than 95%.

30. The method according to claim 28, wherein the mechanical adjustment is undertaken by manually moving the image sources.

31. The method according to claim 28, wherein the mechanical adjustment is undertaken by electronically controlling mechanical movement of the image sources.

32. The method according to claim 28, wherein no adjustments are made to account for any distortion of the projected images.

33. The method according to claim 28, wherein the adjustment is not made to conform the projected images to any electronically stored map of where the images should be located on the liquid resin.

34. The method according to claim 21, wherein the plate is moved substantially continuously, so the method is continuous 3D printing.

35. A system for 3D printing an article, the system comprising an image computer to provide an image to one or more image sources that project the image onto a liquid resin in accordance with claim 21;
an image source computer to control the distance from the one or more image sources to the 2D plane;
a plate computer to control a plate that is movable substantially perpendicular relative to the 2D plane,
wherein the image computer, image source computer and the plate computer cooperate to allow the projected images to cure the liquid resin.
